(19) United States
(12) Patent Application Publication
(10) Pub. No.: US 2018/0339675 A1
(43) Pub. Date: Nov. 29, 2018

(54) SEAT BELT RETRACTOR FOR A VEHICLE, VEHICLE COMPRISING THE SEAT BELT RETRACTOR AND METHOD FOR REGULATING A SEAT BELT RESTRAINING FORCE AND/OR SEAT BELT TENSIONER FORCE LEVEL

(71) Applicant: GM GLOBAL TECHNOLOGY OPERATIONS LLC, Detroit, MI (US)

(72) Inventor: Thomas Jenny, Alsbach-Haehnlein (DE)

(73) Assignee: GM GLOBAL TECHNOLOGY OPERATIONS LLC, Detroit, MI (US)

(21) Appl. No.: 15/987,654

(22) Filed: May 23, 2018

(30) Foreign Application Priority Data
May 23, 2017 (DE) 102017004918.1

(51) Int. Cl. B60R 22/48; B60R 22/46; B60R 21/0132

(52) U.S. Cl. CPC B60R 22/48; B60R 22/46; B60R 2022/4685; B60R 2022/4841; B60R 2022/4666; B60R 21/0132

(57) ABSTRACT

A seat belt retractor is provided for a vehicle and includes a safety seat belt strap for buckling up an occupant on a vehicle seat of the vehicle. The seat belt retractor also includes a regulator for regulating a seat belt restraining force level and/or a seat belt tensioner force level for the safety seat belt strap. A sensor detects restraining and/or tensioning-relevant data. A controller actuates the regulator on the basis of the restraining and/or tensioning-relevant data such that the seat belt retractor generates and/or includes the restraining and/or tensioning-relevant data.

### CROSS-REFERENCE TO RELATED APPLICATION

This application claims priority to German Patent Application No. 102017004918.1, filed May 23, 2017, which is incorporated herein by reference in its entirety.

### TECHNICAL FIELD

The present disclosure pertains to a seat belt retractor for a vehicle and a method for regulating a seat belt restraining force and/or seat belt tensioner force level.

### BACKGROUND

It is generally known that restraining seat belt systems, which can be actuated on the basis of sensor data, may be integrated in many vehicles. For example, DE 2249759 A1 describes a restraining system for occupants of a motor vehicle having a safety seat belt and devices for automatically tightening the safety seat belt. The tightening occurs when a sensor is triggered with a defined acceleration threshold. The level of the tightening force of the safety seat belt can be adjusted by a control system as a function of the vehicle acceleration, deceleration and/or a weight of the respective occupant.

### SUMMARY

The present disclosure is provides a functionally improved seat belt retractor for a vehicle. Embodiments of the present disclosure follow from the specification, claims and accompanying drawings. A seat belt retractor for a vehicle, such as a passenger car, truck or bus, is proposed. The seat belt retractor includes a safety seat belt strap for buckling up an occupant on a vehicle seat of the vehicle. The vehicle seat may preferably be a seat of a rear row of seats of the vehicle. In the alternative, the vehicle seat may also be a seat of a front row of seats, in particular as a driver's seat or front passenger's seat. It is advantageous that the seat belt retractor may be used for all rows of seats of the vehicle.

The seat belt retractor include a rotatably supported seat belt reel, on which the safety seat belt strap is arranged. The safety seat belt strap is in particular rolled up on the seat belt reel and can be unrolled and/or extended therefrom to buckle up the occupant. Specifically, the safety seat belt strap can be rolled up again onto the seat belt reel after the occupant has unbuckled. The seat belt reel preferably rotates, when the safety seat belt strap is extended from it and is rolled up on it. The seat belt reel can be locked against a rotation, so that the safety seat belt strap is blocked. In the case of a locked seat belt reel, a further extension of the safety seat belt strap from the seat belt reel is blocked. The locking of the seat belt reel and the tensioning of the safety seat belt strap occurs in response to a sudden forward movement of the occupant on the vehicle seat, for example in response to and/or during a frontal impact of the vehicle.

The seat belt retractor also includes a regulator for generating, regulating, transmit and/or limiting a seat belt restraining force level and/or seat belt tensioner force level. The regulator preferably generates, regulates, transmits and/or limits a seat belt restraining force and/or seat belt tensioner force on the safety seat belt strap. Any slack in response and/or during an impact of the vehicle can specifically be reduced, in particular adapted to a size and/or to a weight of the occupant on the vehicle seat. The regulator may be electrically switchable, e.g. electro-mechanically, electro-magnetically, electro-pneumatically and/or electro-hydraulically. The regulator can be actuated by a control, regulating and/or evaluation device of the seat belt retractor referred hereinafter as a controller.

In an embodiment, the regulator includes an electrically switchable torsion bar. The torsion bar is preferably arranged coaxially with the seat belt reel. The seat belt reel may be a hollow reel, in which the torsion bar is arranged. Specifically, the torsion bar is in an operative connection with the seat belt reel. The torsion bar makes it possible to also release and/or unblock the seat belt strap, which is tensioned and blocked by the locked seat belt reel. In particular, the torsion bar reel can be twisted and can thus continue to rotate the seat belt reel.

In an additional embodiment, the regulator includes at least one electrically switchable braking device, such as a disk brake or a drum brake. The braking device is configured to decelerate the seat belt extension and/or a seat belt retraction, in particular a speed and/or acceleration, with which the safety seat belt strap is extended from the seat belt reel and/or is retracted into the seat belt reel.

In the alternative or optionally additionally, the regulator includes at least one electrically switchable seat belt tensioner for tensioning the safety seat belt strap. The seat belt tensioner is configured to trigger a rotation of the seat belt reel and to thus roll up and to tension the safety seat belt strap onto the seat belt reel. In the alternative or optionally additionally, the seat belt tensioner is also configured to lock the seat belt reel and to thus block the seat belt extension. The seat belt tensioner is configured for example as a pyrotechnical device or a spring device. In a preferred embodiment, the seat belt tensioner is a pyrotechnical actuator.

The regulator may also include at least one electrically switchable rotary lock and/or at least one electrically switchable rotary stop, which are configured to block the rotation of the seat belt reel.

Optionally, the seat belt retractor has a housing for the regulator. The regulator is preferably arranged in or on the housing. The seat belt tensioner, the seat belt reel, the torsion bar, the rotary lock, the rotary stop and/or the braking device are also preferably arranged in or on the housing. In the alternative or optionally additionally, the controller is arranged in or on the housing. It can, however, also be installed at a different location in the vehicle. In this case, the controller is connected to the regulator, e.g. via a BUS system, in terms of data communication and signaling.

The seat belt retractor includes a sensor, which is configured to detect restraining and/or tensioning-relevant data. The restraining and/or tensioning-relevant data is preferably suitable and/or configured as base for an actuation of the regulator. The sensor includes for example at least one sensor, which operates in a contact-free manner, in particular at least one electrical, electromagnetic sensor and/or optical sensor. The at least one sensor can for example operate on the basis of ultrasound, laser, light and/or radar.

The seat belt retractor has a controller, which is configured to actuate the regulator on the basis of the restraining and/or tensioning-relevant data. The seat belt retractor includes the restraining and/or tensioning-relevant data and/or generates such data. The safety seat belt strap in particular has the restraining and/or tensioning-relevant data.

In a preferred embodiment of the present disclosure, the safety seat belt strap has a measuring system having scaling, coding, bar code and/or measurements, which includes the restraining and/or tensioning-relevant data for the sensor and/or from which the restraining and/or tensioning-relevant data can be determined. The measuring system is in particular a component, which is signal-modulating for the at least one sensor. Specifically, the measuring system may have electromechanical, electromagnetic, electrically optically readable properties of an electrically modulated signal and may be capable of being read out with at least one corresponding sensor. For this purpose, the sensor may include a transmitting and/or receiving unit.

The measuring system is preferably fastened to the safety seat belt strap. The measuring system is for example fastened to the safety seat belt strap in a positive and/or non-positive manner and/or with a substance-to-substance bond. In the alternative, the measuring system is integrated in the safety seat belt strap. The measuring system is for example sewn, embroidered, adhered and/or welded onto the safety seat belt strap. In the alternative, it is possible that the measuring system forms one of a plurality of seat belt layers of the safety seat belt strap and/or is configured as a part of the safety seat belt strap. The measuring system can for example be detected optically and can be read out by at least one optical sensor. In the alternative or optionally additionally, the measuring system can have electro-mechanically readable properties and can be read out by the at least one electro-mechanical sensor.

In a preferred structural implementation of the present disclosure, the restraining and/or tensioning-relevant data include at least a length of a strap extension of the safety seat belt strap from the seat belt reel. The restraining and/or tensioning-relevant data specify in particular, how far the safety seat belt strap is extended and/or unrolled from the seat belt reel. Due to the fact that the length of the strap extension is a function of a girth and/or weight of the occupant, who is buckled up on the vehicle seat, the restraining and/or tensioning-relevant data is occupant-based data, in particular in the case of the length of the strap extension. Robust, accurate and/or time-independent occupant data can be detected by the seat belt retractor. It can also be determined from the length of the strap extension, whether the occupant leans forward, in the driving direction of the vehicle, and thus has a body position, which is displaced forward, and more particularly is “out of position”. The regulation of the seat belt restraining force level and/or of the seat belt tensioner force level can thus be adapted to the individual build, corpulence and size of the occupant and to the body position. Optionally, an airbag, in particular frontal airbag, which is assigned to the occupant, can be deactivated or deployed with a delay in response to a detection of the body position, which is displaced forward.

It is particularly preferred in the context of the present disclosure that values, which are time-dependent on the length of the strap extension, can be determined and/or calculated from the restraining and/or tensioning-relevant data. The time-dependent values are in particular at least a strap extension speed and/or at least a strap extension acceleration.

In a preferred embodiment of the present disclosure, the sensor includes the restraining and/or tensioning-relevant data from the measuring system.

The sensor is for example arranged on the housing. It is also possible that the sensor is arranged on a component of the seat belt retractor, which surrounds the seat belt strap. In the alternative, the sensor can also be arranged on a chassis of the vehicle. The sensor is arranged in the seat belt retractor and/or in the vehicle in such a way that it can effectively detect and/or read out the restraining and/or tensioning-relevant data.

The sensor preferably transmits the restraining and/or tensioning-relevant data as at least one sensor signal to the controller. The sensor detects at least one absolute and/or relative length of the strap extension. Optionally additionally, the sensor detects the at least one seat belt extension strap speed and/or seat belt extension strap acceleration either directly or indirectly.

It is preferred in the context of the present disclosure that the controller evaluates the at least one sensor signal as a control signal, for example on the basis of an algorithm. The controller evaluates the at least one sensor signal, e.g. on the basis of the algorithm and determines the strap extension length of the safety seat belt strap therefrom. Optionally additionally, the controller evaluates the values, which are time-dependent on the length of the strap extension, in particular the strap extension speed and/or the strap extension acceleration of the safety seat belt strap. The algorithm may be stored in memory associated with the controller or a processor, which is connected to the controller. It is also particularly preferred that the controller evaluates the sensor signal continuously, including prior to and during a vehicle impact.

The controller preferably evaluates the restraining and/or tensioning-relevant data as absolute variables, e.g. in the case of the evaluation of the length of the seat belt strap extension. Optionally additionally, the controller evaluates the restraining and/or tensioning-relevant data as relative variables, in particular when the seat belt strap extension speed or the seat belt strap extension acceleration is determined.

In a preferred embodiment of the present disclosure, the controller transmits the control signal to the regulator, in particular to the torsion bar, to the seat belt strap tensioner, to the rotary lock, to the rotary stop, and/or to the braking device. The controller in particular controls the regulator on the basis of the control signal. The control signal is preferably directed to a regulation of the seat belt restraining force level and/or of the seat belt tensioner force level of the regulator. The regulator is actuated to change and/or to regulate the seat belt restraining force and/or seat belt tensioner force, which is switched prior to or during the impact of the vehicle, as a function of the seat belt extension sensor signal or the time-dependent values, which are derived therefrom. This can preferably also be implemented and/or occur repeatedly, as a closed loop.

For example, the braking device may be actuated to decelerate the seat belt extension speed or acceleration and/or the seat belt retraction speed or acceleration as a function of the restraining and/or tensioning-relevant data. In the alternative or optionally additionally, the torsion bar may be actuated to release the safety seat belt strap in a certain length, in particular according to the occupant-based data. In particular the seat belt restraining force and/or seat belt tensioner force can thus be increased or reduced. It is also possible in the context of the present disclosure that the seat belt strap tensioner, in the embodiment as the pyrotechnical actuator, may be actuated to wind the safety seat belt strap onto the seat belt reel and/or to tension the safety seat belt strap.

The seat belt retractor including the occupant-based restraining force regulation provides large advantages for occupants who sit on the vehicle seat of the rear row of seats, because a frontal airbag to protect the occupant seated behind a front seat is not integrated in the respective seat. In addition, a distance between the vehicle seat of the rear row of seats and the front seat is often dimensioned to be relatively small. Due to the possibility of the occupant-based regulation of the seat belt tensioner force level and/or of the seat belt restraining force level, the increase or decrease of the seat belt restraining force and/or the seat belt tensioner force of the regulator, a head impact of the occupant on the front seat, in the body position of the occupant, which is displaced forward. In addition, a length, speed and/or acceleration of the seat belt strap extension can be adapted as a function of the occupant-based data, which can be determined from the length of the seat belt strap extension.

As an alternative for the possible arrangement of the sensor on the housing of the seat belt retractor, it is possible in the context of the present disclosure that the sensor is arranged spaced apart from the housing. It is possible that the sensor is arranged on a component of the seat belt retractor, which surrounds the seat belt strap. The sensor can be arranged in an interior of the vehicle and/or on the vehicle chassis.

A vehicle including the seat belt retractor according to the previous description forms a further subject matter of the present disclosure.

A method for regulating a seat belt tensioner force level and/or seat belt restraining force level for the safety seat belt strap with a seat belt retractor forms a further subject matter of the present disclosure. The seat belt retractor is preferably configured according to the previously described embodiments. In the context of the method, the sensor detects the restraining and/or tensioning-relevant data, which the seat belt retractor generates. The controller actuates the regulator on the basis of the restraining and/or tensioning-relevant data.

In the context of the method, the sensor preferably transmits the restraining and/or tensioning-relevant as at least one sensor signal to the controller. The restraining force-relevant data includes a strap extension length and optionally additionally data, which is time-dependent on the strap extension length. The controller specifically evaluates the sensor signal and generates a control signal therefrom. The controller preferably actuates the regulator on the basis of the control signal. It is particularly preferred that the seat belt restraining force and/or seat belt tensioner force, which is generated and/or transmitted by the regulator, is regulated, increased or reduced in the context of the method.

Optionally additionally, the sensor signal can be used to suppress or to time-control airbag deployments in the vehicle when a deployment of the airbag is not necessary or is necessary in a time-delayed manner as a result of the provided seat belt retractor and the occupant-based restraining force associated therewith. On the basis of the at least one sensor signal, at least one airbag is actuated to suppress the deployment. This is the case, for example when the seat belt retractor is assigned to a vehicle seat of the front row of seats and when the airbag is arranged in a steering wheel or dashboard of the vehicle. By suppressing the airbag deployment, damages to the steering wheel and/or to the dashboard, which are caused by an activated airbag, can be avoided in an advantageous manner. In addition, repair costs incurred for the damages can be saved.

In a preferred method, the seat belt reel initially blocks mechanically, optionally by a centrifugal force locking, at the beginning of the impact of the vehicle. The seat belt strap is then retracted with a pyrotechnical tensioner to remove the slack and to decelerate the occupant immediately, without an excessive force level, which acts on the occupant as a result, or an excessive force peak, respectively, which acts on the occupant. Due to a further forward displacement of the occupant, the seat belt restraining force level can now increase. The sensor-based control of the seat belt restraining force level now occurs in that for example the torsion bar is switched to a higher force level, in particular when an occupant with a large weight was detected by the evaluation of the signal.

The seat belt tensioning occurs by seat belt strap retraction at the beginning of the impact, when virtually no forward displacement of the occupant has occurred yet. In the event of a multi-stage seat belt strap tensioner, a tensioning force can be actuated accordingly. The controller can optionally determine differences by the detected length of the seat belt strap extension when buckling up or also during the drive prior to the impact, so as to then actuate the seat belt tensioner in different ways. After the impact, an occupant-dependent adjustment of the seat belt strap restraining force level is then substantially actuated and/or regulated, for example in that the torsion bar is switched and/or in that a locking, a stop or a continuously regulated deceleration of the seat belt reel occurs by the at least one braking device, rotary lock and/or the rotary stop.

### BRIEF DESCRIPTION OF THE DRAWINGS

The present disclosure will hereinafter be described in conjunction with the following drawing figures, wherein like numerals denote like elements.

FIG. 1 shows a schematic illustration of a seat belt retractor 1 for a vehicle.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

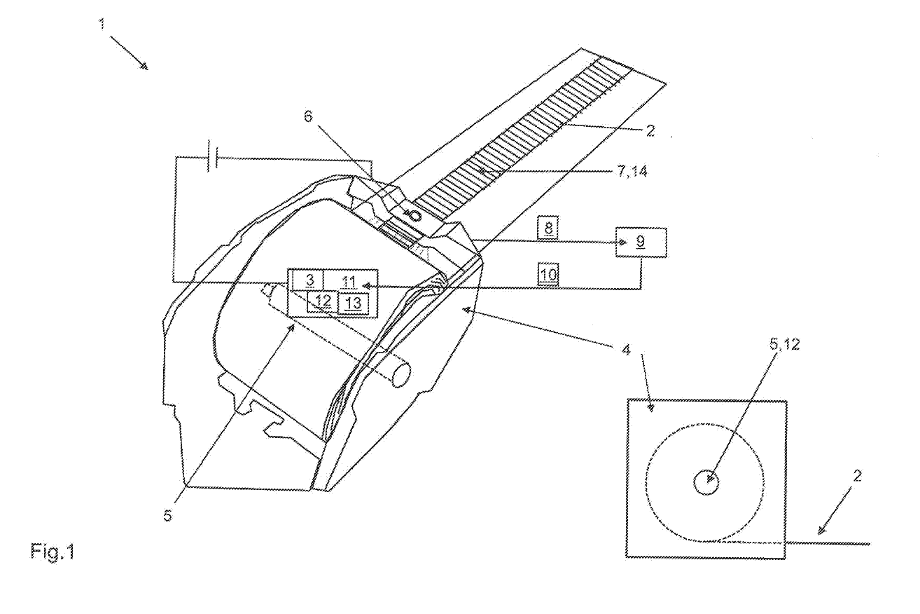

FIG. 1 shows a schematic illustration of a seat belt retractor 1 for a vehicle. The vehicle may be configured as a passenger car, truck or bus. The seat belt retractor 1 includes a safety seat belt strap 2, by which an occupant sitting on a vehicle seat of the vehicle can be buckled up.

The vehicle seat may be configured as a seat of a rear row of seats of the vehicle. In the alternative, the vehicle seat may also be configured as a seat of a front row of seats, in particular as a driver's seat or a passenger's seat of the vehicle. The seat belt retractor 1 is assigned to the vehicle seat as safety device for the occupant sitting on the vehicle seat.

The seat belt retractor 1 includes a seat belt reel 5, on which the safety seat belt strap 2 is arranged. The safety seat belt strap 2 can be unrolled and/or extended from the seat belt reel 5 to buckle up the occupant on the vehicle seat. In response to and/or after buckling up the occupant, the safety seat belt strap 2 can be rolled onto the seat belt reel 5 again. The seat belt reel 5 is rotatably supported for unrolling and rolling up. The seat belt reel 5 is configured as a hollow body.

The seat belt retractor 1 includes an electrically and/or electromechanically switchable device or regulator 11, which is configured to regulate a seat belt restraining force level and/or seat belt tensioner force level. The regulator 11 may regulate, increase or decrease a seat belt restraining force and/or seat belt tensioner force.

The regulator 11 has an electrically and/or electromechanically switchable seat belt strap tensioner 3, which is configured as a pyrotechnical device or as a spring device. In a preferred embodiment, the seat belt strap tensioner 4 is configured as a pyrotechnical actuator. The seat belt strap tensioner 4 is configured to lock the seat belt reel 5 in response to an abrupt retraction movement of the safety seat belt strap 2, which may be caused, for example, by a frontal impact of the vehicle, and to block the safety seat belt strap 2 against a further extension.

The regulator 11 includes a rotatable, electrically and/or electro-mechanically switchable torsion bar 12. The torsion bar 12 is arranged in the seat belt reel 5, which is configured as hollow body, and coaxially thereto. When the seat belt reel 5 is locked, the torsion bar 11 makes it possible to extend the safety seat belt strap 2 a bit further from the seat belt reel 5 by rotation.

The regulator 11 has an electrically and/or electro-mechanically switchable braking device 13, which can be configured as a drum or disk brake. The braking device 13 is configured to decelerate a seat belt extending speed or acceleration on the seat belt reel 5. In the alternative or optionally additionally, the braking device 13 is configured to decelerate a seat belt retraction speed or acceleration into the seat belt reel 5.

In an alternative embodiment, the regulator 11 may also have at least one electrically and/or electro-mechanically switchable rotary lock and/or rotary stop for blocking the rotation of the seat belt reel 5.

The seat belt retractor 1 includes a housing 3, in or on which the regulator 11, the torsion bar 12, the braking device 13, the seat belt tensioner 3 and the seat belt reel 5 are arranged. Optionally, the rotary lock and/or the rotary stop can also be arranged in or on the housing 3.

The seat belt retractor 1 has a sensor 6, which is arranged on the housing 3 above the safety seat belt strap 2. The sensor 6 is for example configured as at least one sensor, which operates in a contact-free manner, as at least one electro-magnetic sensor and/or optical sensor.

The sensor 6 is configured to detect restraining and/or tensioning-relevant data 7 of the seat belt retractor 1. The sensor 6 hereby detects the restraining and/or tensioning-relevant data 7 prior to and during the impact of the vehicle. The seat belt retractor 1 includes the restraining and/or tensioning-relevant data 7. In the alternative or in addition, the restraining and/or tensioning-relevant data 7 is generated in the seat belt retractor 1.

The safety seat belt strap 2 has the restraining and/or tensioning-relevant data 7. The restraining and/or tensioning-relevant data 7 is detected and/or integrated in a measuring system 14 having scaling, coding, bar code and/or measurements, which are arranged on the safety seat belt strap 2. For example, the measuring system 14 is applied to the safety seat belt strap 2 by sewing and/or embroidering. It is also possible that the measuring system 14 is adhered and/or secured onto the safety seat belt strap 2. In the alternative, it is possible that the measuring system 14 is integrated in the safety seat belt strap 2, for example in that the safety seat belt strap 2 includes a plurality of seat belt layers and one of the layers supports the measuring system 14.

The restraining and/or tensioning-relevant data 7 includes information about an absolute and/or relative length of a strap extension of the safety seat belt strap from the seat belt reel 5. Further data, which is a function of the length of the strap extension, can furthermore also be detected and/or determined from the restraining and/or tensioning-relevant data. Such data is, e.g. a strap extension speed and/or a strap extension acceleration.

By way of the length of the strap extension and/or the temporally-derived variables as absolute values, a conclusion can be drawn to a build, corpulence and/or weight of the occupant, who is buckled up on the vehicle seat by the safety seat belt strap. The seat belt retractor 1 thus provides for the regulation of the seat belt restraining force level and/or of the seat belt tensioner force level as a function of the build, corpulence and/or weight of the occupant.

A body position of the occupant on the vehicle seat can also be determined from the length of the strap extension. This is advantageous in the case of a body position, which is displaced forward, because the type and an extent of the seat belt tensioning and/or a deployment of an airbag, which is assigned to the occupant, can be actuated accordingly. The restraining force level can thus be actuated in a prescribed way. Such a seat belt retractor 1 is advantageous in particular for the rear row of seats of the vehicle, because the respective front seat typically does not have a frontal airbag and the space between the rear row of seats and the front seat is limited.

The seat belt retractor 1 includes a control, regulating and/or evaluation device or simply controller 9, which is connected to the sensor 6 in terms of signaling. The sensor 6 transmits the restraining and/or tensioning-relevant data 7 as at least one sensor signal 8 to the controller 9.

The controller 9 evaluates the restraining and/or tensioning-relevant data 7 as a function of the received sensor signal 8 based on an algorithm as a control signal 10. The algorithm is stored in memory associated with the controller 9 or a processor, which is connected to the controller 9.

The controller 9 transmits the control signal 10 to the regulator 11. The control signal 10 is directed to triggering the regulation of the seat belt restraining and/or seat belt tensioner force. In particular, the regulation, increase or decrease of the seat belt restraining force and/or seat belt tensioner force of the regulator 11 is controlled as a function of the information relating to the length of the strap extension and relating to the information, which is time-dependent on the length of the strap extension, which is gathered from the restraining and/or tensioning-relevant data 7. The regulator is actuated to change or regulate the seat belt restraining force and/or seat belt tensioner force or the time-dependent values derived therefrom as a function of the sensor signal 8 and by the control signal 10, which is based thereon. The actuation occurs prior to and/or during a collision event. It can also occur repeatedly within a closed loop.

The torsion bar 12, the braking device 13, the seat belt strap tensioner 3 and optionally additionally the rotary lock and/or the rotary stop are in particular actuated to regulate, increase or decrease the seat belt restraining force and/or seat belt tensioner force via the control signal 10. This occurs for example by a systematic release of the safety seat belt strap 2 in the case of a locked seat belt reel 5 by the torsion bar, by a deceleration of the seat belt retraction and/or seat belt extension speed and/or acceleration by the braking device, by a time-adapted triggering of the lock of the seat belt reel 5 by the seat belt tensioner 3 and/or by a blockade of the rotation of the seat belt reel 5 by the rotary lock and/or the rotary stop.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-15. (canceled)

16. A seat belt retractor for a vehicle comprising:
a safety seat belt strap for buckling up an occupant on a vehicle seat of the vehicle;
a regulator configured to regulate at least one of a seat belt restraining force level or a seat belt tensioner force level for the safety seat belt strap;
a sensor configured to detect at least one of restraining force data or tensioning force data; and
a controller in data communication with the sensor and configure to actuate the regulator based on the restraining force data or the tensioning force data for controlling the safety seat belt strap.

17. The seat belt retractor according to claim 16, wherein the safety seat belt strap comprises a measuring system for the restraining force data or tensioning force data.

18. The seat belt retractor according to claim 17, wherein the measuring system includes at least one of a scaling, a coding, a bar code or a measurement from which the restraining force data or tensioning force data can be determined.

19. The seat belt retractor according to claim 18, wherein the measuring system is fastened to the safety seat belt strap.

20. The seat belt retractor according to claim 18, wherein the measuring system is integrated in the safety seat belt strap.

21. The seat belt retractor according to claim 16, wherein the seat belt retractor comprises a seat belt reel on which the safety seat belt strap is arranged and from which the safety seat belt strap can be extended, wherein the restraining force data or tensioning force data includes a length of a strap extension of the safety seat belt strap from the seat belt reel.

22. The seat belt retractor according to claim 16, wherein the sensor comprises a touchless sensor which operates in a contact-free manner,

23. The seat belt retractor according to claim 22, wherein the touchless comprises an optical sensor.

24. The seat belt retractor according to claim 16, wherein the sensor is configured to detect the restraining force data or tensioning force data from a measuring system having at least one of a scaling, a coding, a bar code or a measurement and transmit a sensor signal representative of the data to the controller.

25. The seat belt retractor according to claim 24, wherein the controller is configured to continuously evaluate the sensor signal and determine therefrom a strap extension length for the safety seat belt strap.

26. The seat belt retractor according to claim 25, wherein the controller is configured to determine time-dependent values of the strap extension length.

27. The seat belt retractor according to claim 24, wherein the controller is configured to evaluate the sensor signal, generate a control signal based on the evaluated sensor signal, and actuate the regulator based on the control signal.

28. The seat belt retractor according to claim 27, wherein the control signal adjusts at least one of a seat belt restraining force or a seat belt tensioner force generated by the regulator on the safety seat belt strap.

29. The seat belt retractor according to claim 16, wherein the regulator comprises a torsion bar for selectively releasing a seat belt extension of the safety seat belt strap.

30. The seat belt retractor according to claim 16, wherein the regulator comprises a belt strap tensioner for selectively tensioning the safety seat belt strap.

31. The seat belt retractor according to claim 16, wherein the regulator comprises a braking device for selectively decelerating relative movement between the safety seat belt strap and the seat belt reel.

32. The seat belt retractor according to claim 16, wherein the regulator comprises a rotary lock for selectively blocking the rotation of the rotary reel.

33. The seat belt retractor according to claim 16, wherein the seat belt retractor comprises a housing for the regulator, wherein the sensor is arranged on the housing.

34. A seat belt retractor for a vehicle comprising:
a regulator housing;
a safety seat belt strap for buckling up an occupant on a vehicle seat of the vehicle;
a seat belt reel on which the safety seat belt strap is arranged and from which the safety seat belt strap can be extended;
a regulator having configured to regulate at least one of a seat belt restraining force level or a seat belt tensioner force level for the safety seat belt strap, the regulator including a torsion bar for selectively releasing a seat belt extension of the safety seat belt strap, a belt strap tensioner for selectively tensioning the safety seat belt strap, a braking device for selectively decelerating relative movement between the safety seat belt strap and the seat belt reel, and a rotary lock for selectively blocking the rotation of the rotary reel;
a sensor arranged on the housing and configured to detect at least one of restraining force data or tensioning force data, wherein the restraining force data or tensioning force data includes a length of a strap extension of the safety seat belt strap from the seat belt reel; and
a controller in data communication with the sensor and configure to selectively actuate at least one of the torsion bar, the belt strap tensioner, the braking device or the rotary lock based on the restraining force data or the tensioning force data for controlling the safety seat belt strap.
